(19) United States
(12) Patent Application Publication
(10) Pub. No.: US 2026/0079257 A1
(43) Pub. Date: Mar. 19, 2026

(54) APPARATUS AND METHOD FOR DETERMINING THE POSITION OF AN OBJECT IN FRONT OF A DISPLAY SCREEN

(71) Applicant: COMMISSARIAT A L'ENERGIE ATOMIQUE ET AUX ENERGIES ALTERNATIVES, Paris (FR)

(72) Inventors: Sébastien BECKER, GRENOBLE CEDEX 09 (FR); François TEMPLIER, GRENOBLE CEDEX 09 (FR); Michaël PELISSIER, GRENOBLE CEDEX 09 (FR)

(73) Assignee: COMMISSARIAT A L'ENERGIE ATOMIQUE ET AUX ENERGIES ALTERNATIVES, Paris (FR)

(21) Appl. No.: 19/328,419

(22) Filed: Sep. 15, 2025

(30) Foreign Application Priority Data
Sep. 16, 2024 (FR) FR FR2409834

(51) Int. Cl. G01S 17/42; G01S 7/481; G01S 17/89

(52) U.S. Cl. CPC G01S 17/42; G01S 7/4813; G01S 17/89

(57) ABSTRACT

A screen (1) including a substrate (2) that supports photo-emitters (3); a photo-detector (4); a source (5) for emitting a laser beam; and a beam scanning system (6) coupled to the source and able to be driven to scan the laser beam in a scene located in front of the substrate; and an electronic system configured to drive the beam scanning system by a scanning angle setpoint; acquire, from the photo-detector (4), a photo-generated signal corresponding to the detection of the laser beam backscattered by an object in the scene illuminated by the laser beam in accordance with the scanning angle setpoint; and determine a position of the object in the scene, based on the photo-generated signal and on the scanning angle setpoint.

### CROSS-REFERENCE TO RELATED APPLICATIONS

This application claims priority to French Patent Application No. FR2409834, filed on Sep. 16, 2024, the entire contents of which are incorporated herein by reference.

### TECHNICAL FIELD

The field of the invention is that of image display screens. The invention more particularly relates to an interactive screen combining a light emission function and a 3D optical capture function allowing for depth mapping of the scene located in front of the screen.

### PRIOR ART

A touchless 3D technology called Infra-Red Intelligent Surface (IRIS) uses a sensor composed of interlaced infrared (IR) emitters and receivers distributed over a surface. This IRIS technology is for example described in Santoul, E., Hemery, E. and Tuckey, J. (2023), Infra-Red Intelligent Surface for Near-Field Touchless Displays. Information Display, 39:18-21. https://doi.org/10.1002/msid.1408.

IRIS technology is based on the measurement of the intensity and the knowledge of the sensor geometry to derive a 3D point cloud of the scene above the sensor. The sensor operates in the near field, from the surface to a few tens of centimeters above in a continuous detection field.

The sensor operates more specifically by first emitting a controlled pattern of IR light from the array of emitters. The light is then reflected by the objects in front of the sensor, and the reflected light is detected by the array of receivers. The detected light is processed by a signal processing circuit to eliminate noise and the ambient light sources. The resulting 2D image contains information on the type and the x, y, z positions of the objects in front of the sensor. This is used to create a 3D point cloud of the scene in front of the sensor. These data allow the system to infer the intention of a user and interact accordingly.

The maximum detection range of the sensor is of the order of magnitude of the surface size, meaning that a sensor the size of a multifunction mobile phone could detect objects up to a few tens of centimeters, while a sensor the size of a 55-inch screen could detect objects up to a few meters away.

The industrialized IRIS sensor will consist of a stack containing several layers including a substrate, photo-elements (IR emitters and receivers or RGB pixels), and a collimation layer. The collimation layer allows manipulating the infrared light so that it converges towards the receivers. However, this collimation layer introduces additional technological complexity.

### DISCLOSURE OF THE INVENTION

The invention aims to eliminate the need for the collimation layer while improving the performance of 3D capture in the far field, typically greater than 30 cm.

For this purpose, the invention proposes an apparatus comprising:
a screen including a substrate which supports:
   a set of photo-emitters;
   a photo-detector;
   a source for emitting a laser beam; and
   beam scanning system coupled to said source and capable to be driven to scan the laser beam emitted by said source in a scene located in front of the substrate;
an electronic system configured to:
   drive the beam scanning system by means of a scanning angle setpoint;
   acquire, from the photo-detector, a photo-generated signal following the detection of the laser beam backscattered by an object in the scene illuminated by the laser beam in accordance with the scanning angle setpoint;
   determine a position of the object in the scene, based on the photo-generated signal and on the scanning angle setpoint.

Some preferred but not limiting aspects of this apparatus are as follows:
the electronic system is further configured to modify a driving setpoint for the photo-emitters in response to the determination of the position of the object;
the laser source for emitting the laser beam and the beam scanning system are arranged on the substrate;
the screen further comprises a covering cap covering the set of photo-emitters and the photo-detector and the laser source for emitting the laser beam and the beam scanning system are arranged on the covering cap;
the covering cap comprises a waveguide configured to convey the laser beam from the laser beam emission source towards the beam scanning system;
the beam scanning system comprises an optical phased array and a deflector;
the laser beam emission source is a tunable monochromatic source and the deflector is a diffraction grating;
the beam scanning system is an opto-mechanical system;
the beam scanning system comprises a programmable metasurface;
the photo-detector is incorporated into an elementary chip which comprises at least one of the photo-emitters and an electronic circuit;
to determine the position of the object in the scene, the electronic system is configured to determine a time of flight, directly or indirectly, of the laser beam from its emission to its detection by the photo-detector;
to determine the position of the object in the scene, the electronic system is configured to perform a differential measurement of the arrival time.

### BRIEF DESCRIPTION OF THE DRAWINGS

Other aspects, aims, advantages and characteristics of the invention will appear better upon reading the following detailed description of preferred embodiments thereof, given by way of non-limiting example, and made with reference to the appended drawings in which:

FIG. 1A and FIG. 1B are diagrams, respectively in side view and in top view, of a screen of an apparatus according to a first possible embodiment of the invention;

FIG. 2 is a diagram in side view of a screen of an apparatus according to a second possible embodiment of the invention;

FIG. 3 is a diagram in top view of a screen of an apparatus according to a third possible embodiment of the invention;

FIG. 4 is a diagram illustrating the principle of a distance measurement that can be implemented by an apparatus in accordance with the invention;

FIG. 5 is a diagram illustrating the advantage of providing several laser emission sources in an apparatus in accordance with the invention;

FIG. 6 is a diagram of a scanning emission source that can be used within the framework of the invention.

### DETAILED DISCLOSURE OF PARTICULAR EMBODIMENTS

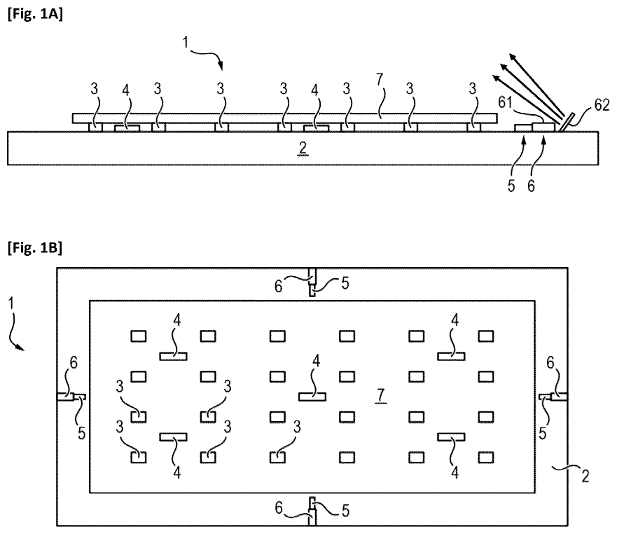

The invention relates to an apparatus comprising a display screen 1, 10, 100, for example for a computer, a multifunction mobile phone, a television or a tablet. With reference to FIGS. 1A, 1B, 2 and 3, the screen includes a substrate 2, for example made of glass, which supports a set of photo-emitters 3 and one or more photo-detectors 4. The screen further includes a covering cap 7, for example made of glass, which covers the photo-emitters 3 and the photo-detector(s) 4.

The substrate 2 preferably supports a plurality of photo-detectors 4 in order to make the measurement described below more robust (for example by averaging the photo-detection signals delivered by the photo-detectors 4). It is therefore possible to distribute several photo-detectors across the surface of the screen, without there necessarily being the same number of photo-detectors 4 as photo-emitters 3.

The photo-emitters 3 of said set form the pixels of the screen. They are typically arranged in a matrix array. In one possible embodiment, the photo-emitters 3 are microLEDs, for example GaN-based microLEDs. The microLEDs may be smart pixels, as described in Templier, F. (2023), MicroLED Technology: A Unique Opportunity Toward “More Than Displays”. Information Display, 39:13-17. https://doi.org/10.1002/msid.1407. Each pixel of the screen can thus be formed by an elementary light-emitting chip which comprises at least one LED and an electronic circuit comprising a member for controlling the at least one LED. Preferably, each elementary chip comprises a plurality of sub-pixels each comprising a LED; typically three sub-pixels associated with LEDs emitting respectively in red, green and blue. The screen can further include a CMOS (Complementary Metal Oxide Semiconductor) drive circuit on the substrate (made of glass for example) for bringing control signals to the smart pixels, this CMOS circuit taking for example the form of a set of conductive lines and columns.

The microLEDs are not necessarily of the smart pixel type and can be driven by a TFT (Thin-Film Transistor) circuit rather than a CMOS circuit. The photo-emitters can be organic diodes called OLEDs or liquid crystal pixels called LCDs.

The photo-detector(s) 4 are able to detect incident radiation and deliver a photo-detection signal. For example, they are able to capture near-infrared radiation, within the silicon detection range (less than 1 μm). Alternatively, they may be able to capture short-wave infrared radiation (between 1 and 2 μm, typically 1.55 μm), which makes them less sensitive to the emission of the photo-emitters 3.

In one possible embodiment, a photo-detector 4 may be carried by an elementary light-emitting chip as described above and whose electronic circuit comprises a member for reading and possibly processing the photo-detection signal delivered by the photo-detector.

The substrate 2 also supports (at least) one emission source 5 of a laser beam and (at least) one beam scanning system 6 coupled to said source 5 and able to be driven to scan the laser beam emitted by said source in a scene located in front of the substrate.

The laser beam may be a beam in the near infrared or in the short wave infrared. It has a range of several meters, or even tens of meters, whereas the IRIS technology is limited to around thirty centimeters.

The beam scanning system 6 can in particular be driven by means of a scanning angle setpoint so that the laser beam emitted towards the scene has a given emission angle relative to the substrate. For a given scanning angle setpoint, the emission source 5 and the scanning system 6 thus provide spot illumination of the scene. Together, the emission source 5 and the scanning system 6 form a scanning emission source.

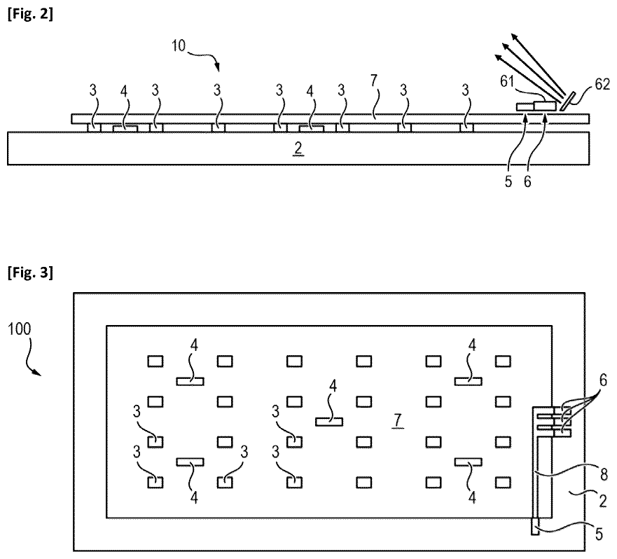

As represented in FIGS. 1A, 1B and 3, the laser beam emission source 5 and the beam scanning system 6 can be arranged on the substrate 2, preferably on its periphery. Alternatively, as represented in FIG. 2, the laser beam emission source 5 and the beam scanning system 6 may be arranged on the covering cap 7, preferably on its periphery.

In one possible embodiment illustrated in FIG. 3, the covering cap may comprise a waveguide 8 configured to convey the laser beam from the emission source 5 towards one or more beam scanning systems 6.

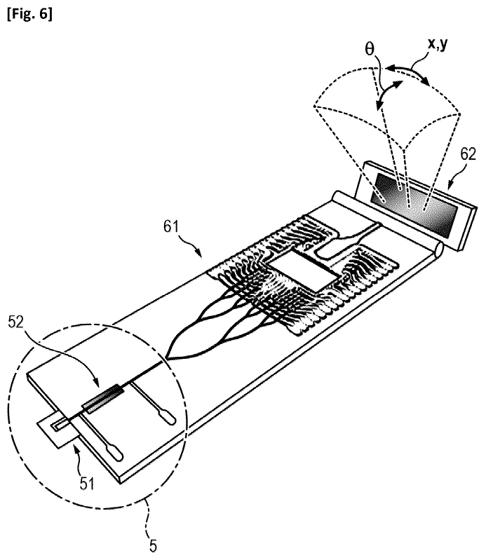

As illustrated in FIG. 6, the beam scanning system 6 may comprise an optical phased array 61 and a deflector 62. The optical phased array 61 may be driven, in particular by means of a heater, to scan the beam in the plane of the substrate 2 (horizontal scanning in x, y). The deflector is an active (for example opto-mechanical) or passive deflector which allows scanning the beam in a plane perpendicular to the substrate 2 (vertical scanning with an angle θ relative to a normal to the substrate). In one possible embodiment, the laser beam emission source 5 is a tunable monochromatic source and the deflector is a passive deflector in the form of a diffraction grating 62 allowing the vertical scanning with an angle θ set by the wavelength of the tunable monochromatic source. The tunable monochromatic source may consist of the association of a superluminescent diode 51 and a Bragg reflector 52 for tuning the wavelength by thermo-optical effect, as described for example in Kim, S M., Lee, E S., Chun, K W. et al. Compact solid-state optical phased array beam scanners based on polymeric photonic integrated circuits. Sci Rep 11, 10576 (2021).

The beam scanning system 6 may comprise several deflectors (having typically different angular deflection ranges) associated with a same emission source. The beam scanning system 6 may also comprise a deflector associated with one or more emission sources. It is also possible to provide for several different emission sources associated with different deflectors.

In another possible embodiment, the beam scanning system may be an opto-mechanical system using for example one or more MEMS (Micro Electro-Mechanical Systems) type mirrors. The opto-mechanical system may comprise a laser beam scanner (LBS). In yet another possible embodiment, the beam scanning system may comprise a programmable metasurface based on phase-change materials.

The apparatus according to the invention further comprises an electronic system for electro-optical driving of the laser source(s) and of the photo-detector(s), and for data processing. This electronic system may take the form of a monolithic or distributed integrated circuit. For example, part of the processing implemented by the electronic system may be carried out by the electronic circuit of a smart-pixel accommodating the photo-detector. It may be the elementary functions of control and low-noise amplification of the signals. Another part of the processing may be carried out by an integrated circuit located at the edge of the screen or remote from the screen, while being electrically connected to the electro-optical components of the screen. This integrated circuit is for example responsible for aggregating the data and processing them in order, on the one hand, to ensure time synchronization and, on the other hand, to extract the useful information (for example, a time-of-flight measurement).

The electronic system is configured to drive the beam scanning system so that the beam scans the scene located in front of the substrate by illuminating for example each spot of the scene successively. At a given moment, the electronic system provides a scanning angle setpoint to the beam scanning system so that the latter directs the beam towards a spot of the scene according to an emission angle.

The electronic system is further configured to:
acquire, from the photo-detector 4, a signal photo-generated by the detection of the laser beam backscattered by an object in the scene illuminated by the laser beam in accordance with the scanning angle setpoint; and
determine a position of the object in the scene, from the photo-generated signal and from the scanning angle setpoint.

For example, the electronic system may be configured to determine a time of arrival of the laser beam backscattered by the object, based on a photo-generated signal and to determine the position of the object, based on the arrival time and on the scanning angle setpoint.

The electronic system may further be configured to modify a driving setpoint for the photo-emitters 3 in response to the determination of the position of the object. The screen is thus interactive in that its display is modified based on the scene located in front of the substrate, for example based on a touchless interaction of a user with the screen.

In a first embodiment, to determine the position of the object in the scene, the electronic system is configured to determine a direct or indirect time of flight of the laser beam from its emission to its detection by the photo-detector.

By determination of a direct time of flight it is meant a measurement of the time elapsed between the emission, by the scanning emission source 5, 6, of a light pulse towards an object in the scene and the time of arrival of this pulse at the photo-detector 4. In this case, the photo-detector 4 may be an avalanche photodiode (APD) or a single photon avalanche diode (SPAD).

By determination of an indirect time of flight it is meant an emission, by the scanning emission source 5, 6, of a modulated light (for example in amplitude) and a measurement (by demodulation) of the phase shift of the light received by the photo-detector. In this case, the photo-detector 4 can be a QE modulation detector (QEM), a lateral electron field detector (LEF) or a current-assisted photonic demodulator (CAPD).

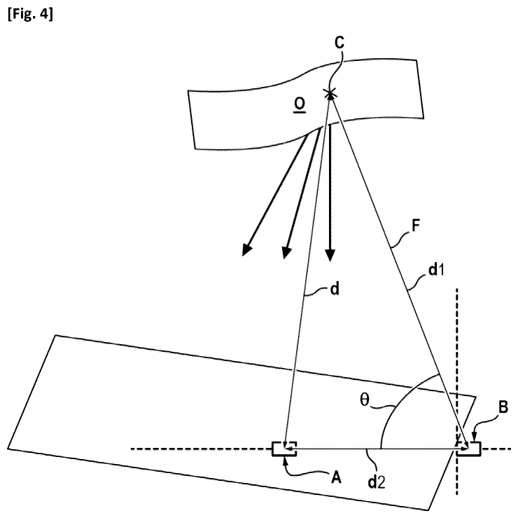

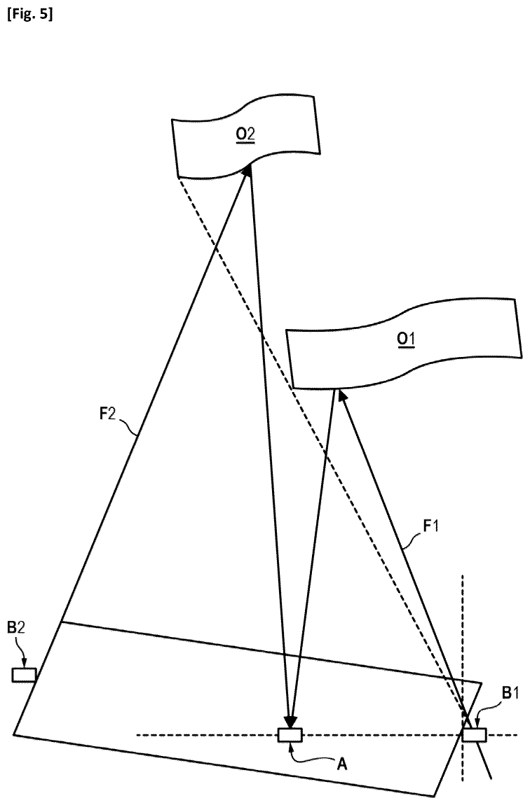

As represented in FIG. 4, the laser beam is emitted from a spot B at an emission angle θ relative to the surface of the substrate or of the cap. The laser beam illuminates a spot C of an object O in the scene and is backscattered in all directions and in particular in the direction of the photo-detector 4 arranged at the spot A.

Knowing the angle θ [symbol] , defined at each moment by the scanning angle setpoint and the position of the photo-detector 4, the position in space of the spot C is determined by the distance d separating the spots A and C.

We have: d²=d1²+d2²+2d1·d2·cos 0, where d1 corresponds to the distance separating the spots B and C and where d2 corresponds to the distance separating the spots B and A.

The time of flight T between the spots B, C, and A is written as

$$T = \frac{d 1 + d}{c} ,$$

where c is the speed of light in a vacuum. The distance d is then written as:

$$d = \frac{{T}^{2} . {c}^{2} + d {2}^{2} + 2 T . c . d 2. cos θ}{2 ( T . c + d 2. cos θ )}$$

It is therefore possible to determine the distance d separating the illuminated spot C from the photo-detector 4 arranged at the spot A using a time-of-flight measurement, knowing the scanning angle setpoint θ and the geometry d2 of the laser beam emission-detection system. Knowing this distance d and the angle θ, it is possible to determine the 3D position of the spot C. By driving the scanning system to successively illuminate the different spots of the scene, it is then possible to map the entire scene in front of the screen in 3D.

The solution described above is based on a distance estimation (d and d1) relative to a measurement of the time of arrival of the photons. To ensure an unambiguous position estimation in the 3D space, it may be necessary to use at least three photo-detectors and perform triangulation measurements. This is in particular useful in the case of interference reflections.

Moreover, in order to improve the accuracy of the arrival time estimation, it may be useful to provide for a highly accurate frequency and phase synchronization clock device between the scanning emission source and the photo-detector(s) in order to accurately estimate the arrival time. One difficulty lies in the size of the screen, which may be relatively large compared to the size of the photo-detector and to the scanning emission source. Common time base/clock solutions between the scanning emission source and the photo-detector or phase-locked loop (PLL) clock recovery solutions within the photo-detector can be implemented to satisfy this synchronization condition.

In a second embodiment, to determine the position of the object in the scene, the electronic system is configured to perform a differential arrival time measurement. By providing for several photo-detectors distributed on the substrate, it is indeed possible to perform a differential measurement of arrival time between the various sensors thus distributed. These sensors are synchronized together but not necessarily with the scanning emission source, and their positions are predefined and known.

FIG. 5 represents the advantage of having several scanning emission sources (here for the emission of a beam F1 from a spot B1 and the emission of a beam F2 from a spot B2) and distributing them on the periphery of the screen to measure the distance of very convex/concave shapes or shapes hidden by the foreground. In this FIG. 5, the object O1 hides the object O2 for the beam F1. However, the object O2 can be reached by the beam F2, and the time of arrival of this beam F2 at the photo-detector arranged at the spot A can be measured.

The invention is not limited to the apparatus previously described but also extends to a method for monitoring such an apparatus, this method comprising the implementation of the following steps by the electronic system of the apparatus:
driving the beam scanning system by means of a scanning angle setpoint;
acquiring, from the photo-detector, a photo-generated signal following the detection of the laser beam backscattered by an object in the scene illuminated by the laser beam in accordance with the scanning angle setpoint;
determining a position of the object in the scene, based on the photo-generated signal and on the scanning angle setpoint.

The invention also extends to a computer program product comprising instructions which, when executed by a computer, cause the latter to implement this monitoring method.

1. An apparatus comprising:
a screen including a substrate which supports:
a set of photo-emitters;
a photo-detector;
a source for emitting a laser beam; and
a beam scanning system coupled to said source and able to be driven to scan the laser beam emitted by said source in a scene located in front of the substrate;
an electronic system configured to:
drive the beam scanning system by means of a scanning angle setpoint;
acquire, from the photo-detector, a photo-generated signal corresponding to the detection of the laser beam having been backscattered by an object in the scene illuminated by the laser beam in accordance with the scanning angle setpoint;
determine a position of the object in the scene, based on the photo-generated signal and on the scanning angle setpoint.

2. The apparatus according to claim 1, wherein the electronic system is further configured to modify a driving setpoint for the photo-emitters in response to the determination of the position of the object.

3. The apparatus according to claim 1, wherein the laser source for emitting the laser beam and the beam scanning system are arranged on the substrate.

4. The apparatus according to claim 1, wherein the screen further comprises a covering cap covering the set of photo-emitters and the photo-detector, and wherein the laser source for emitting the laser beam and the beam scanning system are arranged on the covering cap.

5. The apparatus according to claim 4, wherein the covering cap comprises a waveguide configured to convey the laser beam from the laser beam emission source towards the beam scanning system.

6. The apparatus according to claim 1, wherein the beam scanning system comprises an optical phased array and a deflector.

7. The apparatus according to claim 6, wherein the laser beam emission source is a tunable monochromatic source and wherein the deflector is a diffraction grating.

8. The apparatus according to claim 1, wherein the beam scanning system is an opto-mechanical system.

9. The apparatus according to claim 1, wherein the beam scanning system comprises a programmable metasurface.

10. The apparatus according to claim 1, wherein the photo-detector is incorporated into an elementary chip which comprises at least one of the photo-emitters and an electronic circuit.

11. The apparatus according to claim 1, wherein, to determine the position of the object in the scene, the electronic system is configured to determine a time of flight, directly or indirectly, of the laser beam from its emission to its detection by the photo-detector.

12. The apparatus according to claim 1, wherein, to determine the position of the object in the scene, the electronic system is configured to perform a differential measurement of the arrival time.

13. A method for monitoring an apparatus according to claim 1, comprising the implementation of the following steps by the electronic system:
driving the beam scanning system by means of a scanning angle setpoint;
acquiring, from the photo-detector, a photo-generated signal corresponding to the detection of the laser beam backscattered by an object in the scene illuminated by the laser beam in accordance with the scanning angle setpoint;
determining a position of the object in the scene, based on the photo-generated signal and on the scanning angle setpoint.

14. A computer program comprising instructions which, when executed by a computer, cause the latter to implement the method according to claim 13.
